(19) United States
(12) Patent Application Publication
(10) Pub. No.: US 2022/0073292 A1
(43) Pub. Date: Mar. 10, 2022

(54) EFFICIENT BRAKING AND ANTI-TAIL TIP CARGO HANDLING SYSTEMS

(71) Applicant: Goodrich Corporation, Charlotte, NC (US)

(72) Inventor: Vinodkumar Shivalinga, Bangalore (IN)

(73) Assignee: Goodrich Corporation, Charlotte, NC (US)

(21) Appl. No.: 17/133,232

(22) Filed: Dec. 23, 2020

(30) Foreign Application Priority Data
Sep. 4, 2020 (IN) 202041038272

(51) Int. Cl. B65G 65/00; B65G 13/075; B65G 13/02; G01G 11/04; B64D 9/00; G05B 19/042

(52) U.S. Cl. CPC B65G 65/005; B65G 13/075; B65G 13/02; G01G 11/04; G05B 2219/2621; G05B 19/042; B65G 2203/0258; B65G 2207/40; B64D 2009/006; B64D 9/003

(57) ABSTRACT

A cargo handling system may comprise a roller tray and a power drive unit located in the roller tray. The power drive unit may comprise a drive roller, a motor configured to drive a rotation the drive roller, and a load cell configured to detect a load applied to the drive roller.

### CROSS-REFERENCE TO RELATED APPLICATIONS

This application claims priority to, and the benefit of, India Patent Application No. 202041038272, filed Sep. 4, 2020 and titled “EFFICIENT BRAKING AND ANTI-TAIL TIP CARGO HANDLING SYSTEMS,” which is incorporated by reference herein in its entirety for all purposes.

### FIELD

The present disclosure relates to cargo handling systems, and more specifically, to systems for reducing occurrences of tail tipping and for controlling brake rollers during cargo loading and unloading.

### BACKGROUND

Conventional aircraft cargo systems typically include various tracks and rollers that span the length of an aircraft. Cargo may be loaded from an aft position on an aircraft and conducted by the cargo system to a forward position and/or, depending upon aircraft configuration, cargo may be loaded from a forward position on an aircraft and conducted by the cargo system to an aft position. Cargo systems, such as those used by aircraft for transport of heavy containerized cargo or pallets, also referred to as unit load devices (ULDs), typically include roller trays containing transport rollers which support the cargo. Motor driven rollers are typically employed in these systems. Aircraft often employ a series of motor driven power drive units (PDUs) to propel cargo containers and pallets within the aircraft cargo compartment. This configuration can allow for the transportation of cargo pallets within the aircraft cargo compartment by one or more operators controlling the PDUs.

The cargo system may also include brake rollers to slow and/or stop translation of the ULDs through the cargo deck. Electromechanical brake rollers are electrically powered to apply braking force. Current electromechanical brake rollers are configured to apply a fixed braking force, as there is a lack of control over the input power supplied to the electromechanics brake roller. The fixed force can be difficult to achieve and tends to require a skilled person to assemble the brake rollers. Additionally, the constant braking force tends to allow lighter ULDs to skid over the non-rotating brake roller, which can lead to the outer braking rubber layer (i.e., the tire) developing a flat or worn spot.

Before loading or unloading the cargo the ground crew may determine a weight balance for the aircraft to avoid tail tipping, wherein the weight of aft section of the aircraft fuselage compared to weight at the forward section causes the tail of the aircraft to translate toward and contact the ground, raising the nose and nose landing gear of the aircraft off the ground. Tail tipping can occur due to lack of communication and/or knowledge regarding the weight of cargo in forward and/or aft section of the aircraft and/or due the aft cargo being loaded prior to the forward section and/or due to the forward section being unloaded prior to the aft section as its.

### SUMMARY

A power drive unit for a cargo handling system is disclosed herein. In accordance with various embodiments, the power drive unit may comprise a drive roller and a motor configured to drive a rotation the drive roller. A biasing member may be configured to bias the drive roller in a first direction. A load cell may be configured to detect a load applied to the drive roller and output an electrical signal.

In various embodiments, a pad may be coupled to a bottom surface of the power drive unit. The drive roller may extend past an upper surface of the power drive unit. The upper surface is opposite the bottom surface. The pad may comprise the load cell.

In various embodiments, a support structure may be coupled to the drive roller. A piston may be configured to telescope relative to the support structure. The piston may be configured to apply force to the load cell.

In various embodiments, the load cell may be configured to output the electrical signal to a controller. The load cell may be configured to output the electrical signal to a brake roller. In various embodiments, the load cell may comprise strain gauge. In various embodiments, the load cell may comprise a piezoelectric material.

A cargo handling system is also disclosed herein. In accordance with various embodiments, the cargo handling system may comprise a roller tray and a first power drive unit located in the roller tray. The first power drive unit may comprise a first drive roller, a motor configured to drive a rotation the first drive roller, and a first load cell configured to detect a first load applied to the first drive roller.

In various embodiments, a brake roller may be electrically coupled to the first load cell. In various embodiments, the brake roller may be configured to adjust a braking force based on an electrical signal output by the load cell.

In various embodiments, a first electrical signal, output by the first load cell, may be configured to generate a first braking force. A second electrical signal, output by the first load cell, may be configured to generate a second braking force, the second braking force being greater than the first braking force.

In various embodiments, the first electrical signal may be configured to generate a first amount of thermal expansion in one more friction disks of the brake roller. In various embodiments, the second electrical signal may be configured to generate a second amount of thermal expansion in the one more friction disks of the brake roller.

In various embodiments, the cargo handling system may further comprise a brake caster. The brake caster may include a cup, a brake caster roller configured to swivel relative to the cup, a thrust bearing located between the brake caster roller and a floor of the cup, and a second load cell located between the thrust bearing and the floor of the cup.

In various embodiments, the cargo handling system may further comprise a second power drive unit. The second power drive unit may include a second drive roller and a second load cell configured to detect a second load applied to the second drive roller.

In various embodiments, a controller may be electrically coupled to the first load cell and the second load cell. The controller may be configured to determine a difference in a weight of an aft section of the cargo handling system and a weight of a forward section of the cargo handling system, The controller may determine the difference using a first electrical signal received from the first load cell and a second electrical signal received from the second load cell.

An article of manufacture including a tangible, non-transitory computer-readable storage medium is also disclosed herein. The tangible, non-transitory computer-readable storage medium may have instructions stored thereon for controlling a cargo handling system. The instructions, in response to execution by a controller, cause the controller to perform operations, which may comprise receiving, by the controller, a first electrical signal from a first load cell and receiving, by the controller, a second electrical signal from a second load cell. The first load cell may be operably coupled to a first power drive unit. The second load cell may be operably coupled to a second power drive unit. The operations may further comprise determining, by the controller, an aft cargo weight in an aft section of the cargo handling system using on the first electrical signal, and determining, by the controller, a forward cargo weight in a forward section of the cargo handling system using on the second electrical signal.

In various embodiments, the operations may further comprise calculating, by the controller, a difference between the aft cargo weight and the forward cargo weight, and comparing, by the controller, the difference between the aft cargo weight and the forward cargo weight to a difference threshold.

In various embodiments, the operations may further comprise commanding, by the controller, at least one of a master control panel of the cargo handling system or a local control panel of the cargo handling system to display an alert if the difference between the aft cargo weight and the forward cargo weight is greater than difference threshold.

In various embodiments, the operations may further comprise deactivating, by the controller, at least one of the first power drive unit or the second power drive unit if the difference between the aft cargo weight and the forward cargo weight is greater than the difference threshold.

In various embodiments, the operations may further comprise reactivating, by the controller, the at least one of the first power drive unit or the second power drive unit in response to the difference between the aft cargo weight and the forward cargo weight decreasing to less than the difference threshold.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like numbers denote to like elements.

FIG. 1A illustrates an aircraft being loaded with cargo, in accordance with various embodiments;

FIG. 1B illustrates a portion of a cargo handling system, in accordance with various embodiments;

FIGS. 2A and 2B illustrate a roller tray of a cargo handling system, in accordance with various embodiments;

FIG. 3 illustrates an assembly view of roller tray components, in accordance with various embodiments;

FIG. 4 illustrates a portion of a PDU including a load cell, in accordance with various embodiments;

FIGS. 5A, 5B, and 5C illustrate a castor brake including a load cell, in accordance with various embodiments; and

FIG. 6 illustrates a schematic view of a cargo deck having a cargo handling system with a plurality of load cells operably coupled to PDUs and caster roller brake rollers, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Surface shading lines may be used throughout the figures to denote different parts but not necessarily to denote the same or different materials. Throughout the present disclosure, like reference numbers denote like elements. Accordingly, elements with like element numbering may be shown in the figures, but may not necessarily be repeated herein for the sake of clarity.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”).

Cargo handling systems, as disclosed herein, are used to load, move, and unload cargo. The present disclosure describes a cargo handling system having load cells operably coupled to PDUs and caster roller brakes within a cargo deck of an aircraft. The load cells are configured to output an electrical signal corresponding to the weight of an object (e.g., ULD) located on the PDU or brake caster roller. In various embodiments, the electrical signals are sent to one or more controller(s), which monitor and compare the weight in the forward and aft sections of the aircraft. In accordance with various embodiments, the controller(s) may be configured to send alerts and/or turn off the PDUs in response to determining a weight differential between the forward and aft sections of the aircraft is greater than a threshold differential. In this regard, the system may reduce occurrences of tail tipping, which increases safety and reduces the potential for damage to the aircraft, cargo, and passengers. In various embodiments, the electrical signal from the load cells may also be sent to electromechanical brake rollers of the cargo handling system. In accordance with various embodiments, the electromechanical brake rollers are configured to adjust their respective braking force based on the electrical signal from the load cells. In this regard, the electromechanical brake rollers are configured to generate a braking force that coincides with the weight of the ULD, such that a greater braking force is generated for heavier objects and a smaller braking force for lighter objects. Adjusting the braking force based on the weight of the object allows for more efficient braking and may increase brake roller life, as it tends to reduce uneven wear of the brake roller, which may be caused by lighter objects translating over the brake roller without generating sufficient force to rotate the brake roller (i.e., the object translates, or slides, along the surface of the brake roller, without rotating the brake roller). While described in relation to use in aircraft, it is contemplated and understood that cargo handling systems and methods disclosed herein may also be suitable for use in non-aircraft cargo handling systems.

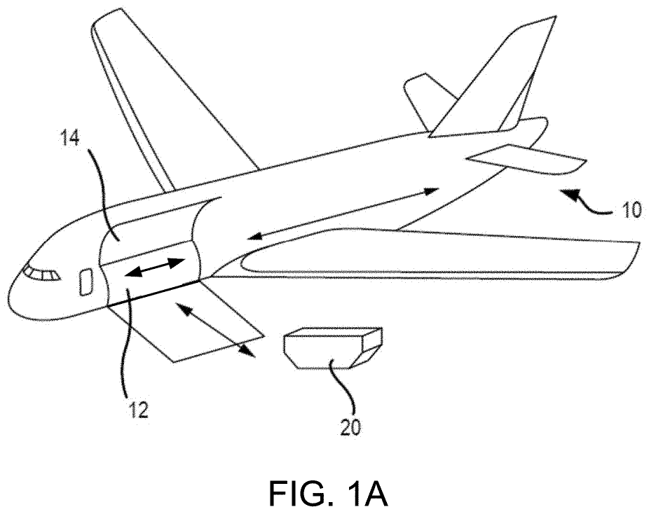

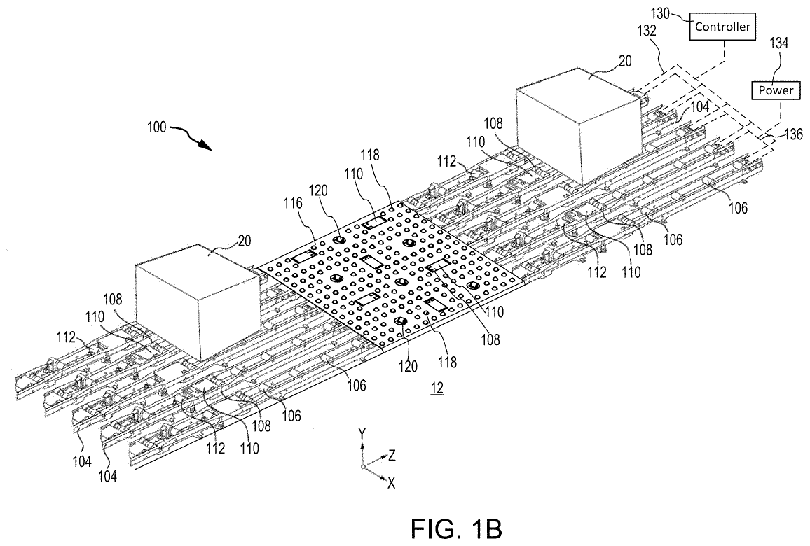

In accordance with various embodiments, and with reference to FIG. 1A, an aircraft 10 having a cargo deck 12 is illustrated. Aircraft 10 may comprise a cargo load door 14, for example, at a side of the fuselage structure of the aircraft 10. Cargo 20 may be loaded through cargo load door 14 and onto cargo deck 12 of aircraft 10 or unloaded from the cargo deck 12 of the aircraft 10.

Items to be shipped by air, freight, and/or the like are typically loaded first onto specially configured pallets or into specially configured containers. In aviation, those various pallets and/or containers are commonly are referred to as unit load devices (ULDs). ULDs are available in various sizes and capacities, and are typically standardized in dimension and shape. In various embodiments, cargo 20 may be a ULD. Once loaded, the ULD is transferred to the aircraft, and is loaded onto the aircraft 10 through the cargo load door 14 using a conveyor ramp, scissor lift, or the like. Once inside the aircraft 10, the ULD is moved within the cargo hold to its final stowage position. Multiple ULDs may be brought on-board the aircraft, with each ULD being placed in its respective stowage and transportation position in on cargo deck 12. After the aircraft 10 has reached its destination, the ULDs are unloaded from the aircraft 10 similarly, but in reverse sequence to the loading procedure. To facilitate movement of cargo 20 along the cargo deck 12, aircraft 10 may include a cargo handling system 100 as described herein in accordance with various embodiments.

With reference to FIG. 1B, a portion of cargo deck 12 is shown in accordance with various embodiments and with XYZ axes for ease of illustration. Cargo deck 12 includes cargo handling system 100. Cargo handling system may include one or more ball panels 116 and one or more roller trays 104. Ball panels 116 may include a plurality of freely rotating conveyance balls 118. Roller trays 104 include a plurality of freely rotating conveyance rollers 106. Roller trays 104 may be positioned longitudinally along cargo deck 12. In various embodiments, a number of PDUs 110 may be mounted along cargo deck 12. For example, PDUs 110 may be located in ball panels 116 and/or in roller trays 104. PDUs 110 are configured to propel cargo over conveyance balls 118 and conveyance rollers 106 and across cargo deck 12.

PDUs 110 include one or more drive rollers 108, which may be actively controlled by a motor. PDUs 110, including drive rollers 108, provide a mechanism upon which cargo 20 is propelled over the conveyance rollers 106. The cargo 20 may contact the drive rollers 108 of PDUs 110 located within the roller trays 104 to provide motive force for the cargo 20. Each PDU 110 may include an actuator, such as an electrically operated motor, which drives one or more drive rollers 108. In various embodiments, a drive roller 108 may be raised by PDU 110 from a lowered position beneath the conveyance surface 102 to an elevated position above conveyance surface 102. As used with respect to cargo handling system 100, the term “beneath” may refer to the negative y-direction, and the term “above” may refer to the positive y-direction with respect to the provided XYZ axes. In the elevated position, a drive roller 108 contacts and drives the overlying cargo 20 that rides on the conveyance rollers 106. In accordance with various embodiments, the drive roller 108 may be held or biased in a position above the conveyance surface by a spring.

In accordance with various embodiments, a number of brake rollers 112 may be located along cargo deck 18. For example, brake rollers 112 may be mounted in roller trays 104. In various embodiments, one or more brake caster(s) 120 may be coupled to ball panel 116. Stated differently, ball panel 116 may include brake caster(s) 120. Brake caster 120 may be configured to swivel (or rotate) relative to ball panel 116, thereby by allowing brake caster 120 to align with the direction of movement of cargo 20 over ball panel 116. In various embodiments, brake rollers 112 and brake casters 120 are configured to rotate freely in a first circumferential direction and restrict rotation in the opposite circumferential direction. In this regard, brake rollers 112 and brake casters 120 may slow or prevent translation of cargo across cargo deck 12 in certain directions.

Cargo handling system 100 may include a controller 130 in communication with the PDUs 110 via a plurality of channels 132. Channel 132 may be a data bus, such as a controller area network (CAN) bus and may include one or more CAN busses or multi-CANs. An operator may selectively control operation of PDUs 110 using controller 130. Controller 130 may be configured to activate and/or deactivate the various PDUs 110 of cargo handling system 100. Thus, cargo handling system 100 may receive operator input through controller 130 to control PDUs 110 to manipulate cargo 20 into a desired position on cargo deck 12. Controller 130 may include a general purpose processor, a digital signal processor (DSP), an application specific integrated circuit (ASIC), a field programmable gate array (FPGA) or other programmable logic device, discrete gate or transistor logic, discrete hardware components, or any combination thereof.

System program instructions and/or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The cargo handling system 100 may also include a power source 134 configured to supply power to the PDUs 110, brake rollers 112, and/or other components of cargo handling system 100 via one or more power busses 136. As described below, in various embodiments, the controller 130 may be complimented by or substituted with one or more local controllers, whereby control of each PDU or groups of PDUs is performed by individual local controllers configured to communicate with one another.

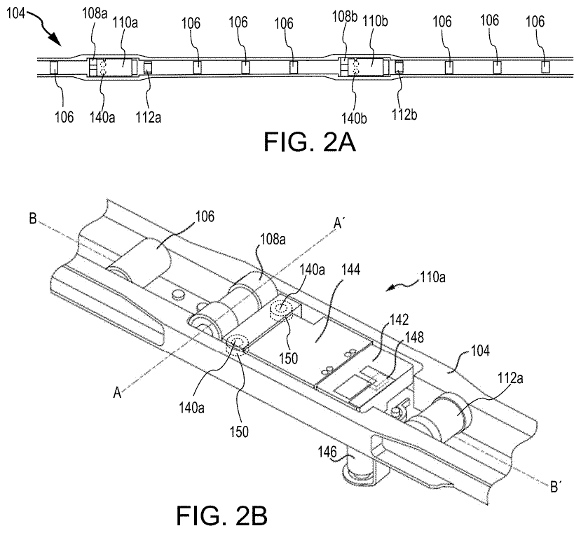

With reference to FIG. 2A, a roller tray 104 is illustrated. In accordance with various embodiments, a first PDU 110a and a second PDU 110b are located in roller tray 104. A first brake roller 112a and a second brake roller 112b are also located in roller tray 104. A plurality of conveyance rollers 106 may also be located in roller tray 104. As described in further detail below, each of first PDU 110a and second PDU 110b includes at least one load cell configured to measure a weight of an object located on the PDU drive roller and output a signal corresponding to the weight of the object to one or more brake rollers 112. In accordance with various embodiments, first PDU 110a includes one or more load cells 140a. Load cells 140a are configured to detect a load applied to drive roller 108a and output an electrical signal corresponding to the load to brake roller 112a. Second PDU 110b includes one or more load cells 140b, similar to load cells 140a. Load cells 140b are configured to output an electrical signal to second brake roller 112b. The electrical signals output by load cells 140a and 140b may also be sent to controller 130, with momentary reference to FIG. 1B.

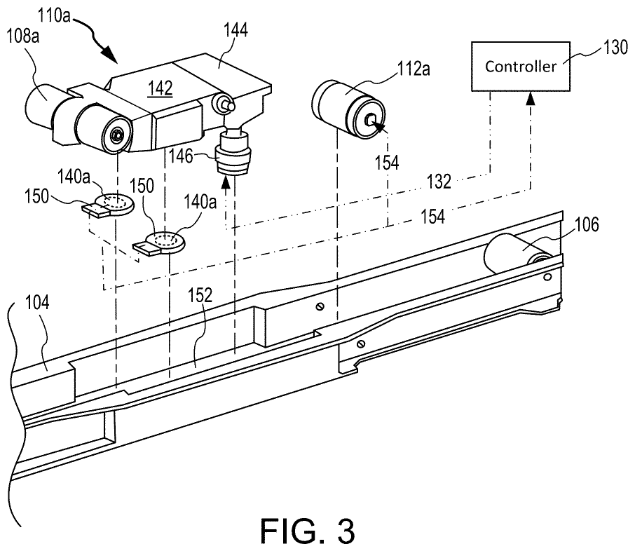

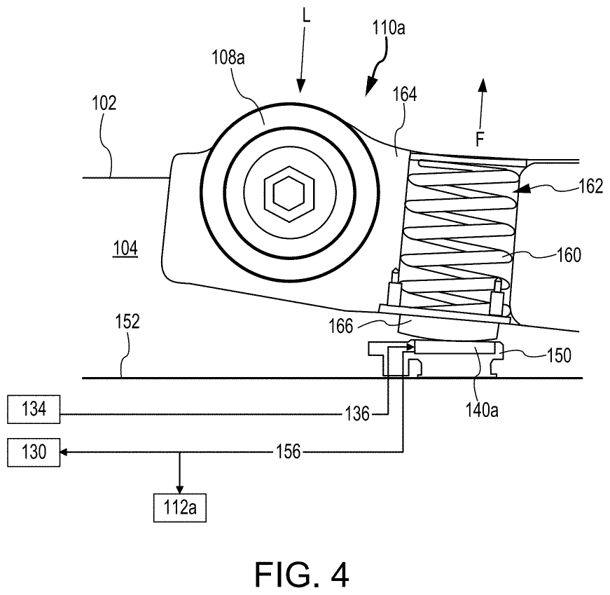

With reference to FIG. 2B, additional details of first PDU 110a are shown, in accordance with various embodiments. While FIG. 2B, FIG. 3, and FIG. 4 show details of first PDU 110a, it is contemplated and understood that the other PDUs 110 of cargo handling system 100 include the features and functionalities as described herein with reference to first PDU 110a.

In accordance with various embodiments, first PDU 110a may comprise a PDU controller 142, a motor 144, a connector 146, and one or more drive rollers 108a mounted within roller tray 104. Drive roller 108a may comprise a cylindrical wheel coupled to drive shaft and configured to rotate about an axis A-A′. Drive roller 108a may be in mechanical communication with the motor 144, which may be, for example, an electromagnetic, electromechanical, or electrohydraulic actuator or other servomechanism. First PDU 110a may further include gear assemblies and other related components for turning and/or raising drive roller 108a so that drive roller 108a may be positioned above the cargo deck 12 to contact the bottom of cargo 20 (see FIG. 2).

First PDU 110a may rotate drive roller 108a in one of two possible directions (i.e., forward or reverse) to propel cargo 20 in a direction parallel to a longitudinal axis B-B′ of roller tray 104. PDU controller 142 may include a processor and a tangible, non-transitory memory. The PDU processor may comprise one or more logic modules that implement logic to control one or more drive roller 108a. In various embodiments, first PDU 110a may comprise other electrical devices to implement drive logic. Connector 146 may be an electrical connector for coupling the electronics of first PDU 110a to a power source and a control source, such as controller 130 and power source 134 in FIG. 2. Connector 146 may have pins and/or slots and may be configured to couple to a wiring harness having pin programing. PDU controller 142 may be configured to receive commands from controller 130 through connector 146. First PDU 110a may receive and interpret commands to control motor 144. In various embodiments, PDU controller 142 may further comprise a radio frequency identification (RFID) reader 148 capable of detecting RFID data. RFID reader 148 may comprise a transmitter, a receiver and/or a transceiver that is configured to transmit and receive power and/or data.

In accordance with various embodiments, first PDU 110a includes one or more load cells 140a. Load cells 140a may be embedded or otherwise coupled to pads 150 of first PDU 110a.

With reference to FIG. 3, an assembly view of components located in roller tray 104 is illustrated. Pads 150 may be located between first PDU 110a and a floor of 152 of roller tray 104. Load cells 140a are included in pads 150. In various embodiments, load cells 140a, 140b may comprise strain gauge. For example, pads 150 may deflect in response to a load applied to drive roller 108a, and load cells 140a may detect and/or measure the deflection of pads 150 and produce an electrical signal indicative of the amount of the deflection. The electrical signals generated by load cells 140a may be output to brake roller 112a and to controller 130 via links 154. Links 154 may be a wired or wireless connection.

The electrical signal output by load cells 140a is configured to be indicative of the weight of an object located on drive roller 108a of first PDU 110a. In various embodiments, first brake roller 112a is electrically coupled to load cells 140a. First brake roller 112a may be an electromechanical brake roller. In this regard, first brake roller 112a may generate braking force in response to receiving an electrical signal. The magnitude of the braking force generated by first brake roller 112a may be based on the electrical signal received from load cells 140a. For example, first brake roller 112a may generate a first braking force in response to receiving a first electrical signal from load cells 140a and a second braking force, greater than first braking force, in response to receiving a second electrical signal from load cells 140a, wherein the first electrical signal is sent in response to a first ULD being located on drive roller 108a and the second electrical signal is sent in response to a second, heavier ULD being located on drive roller 108a.

In various embodiments, the first brake roller 112a may be configured such that the electrical signals received from load cell 140 cause thermal expansion of friction disks located within the first brake roller 112a. In various embodiments, the electrical signals are configured to produce greater thermal expansion when heavier objects are located on drive roller 108a. For example, a first electrical signal received from load cells 140a may cause a first thermal expansion of the friction disks of brake roller 112a, thereby generating a first braking force, and a second electrical signal received from load cells 140a may generate a second, greater thermal expansion of the friction disks, thereby generating a second, greater braking force, wherein the first electrical signal is sent in response to a first ULD being located on drive roller 108a and the second electrical signal is sent in response to a second ULD being located on drive roller 108a, the second ULD being heavier than the first ULD.

With reference to FIG. 4, additional details of a load cell 140a operably coupled to first PDU 110a are shown. In accordance with various embodiments, first PDU 110a may include a biasing member 160. Biasing member 160 may be located within a spring cavity 162 defined by a support structure (or housing) 164 of first PDU 110a. Support structure 164 may be coupled to and support drive roller 108a. Biasing member 160 is configured to apply a biasing force F to support structure 164 of first PDU 110a. Biasing force F biases support structure 164 away from the floor 152 of roller tray 104. Stated differently, biasing force F biases drive roller 108a away from the floor 152 and toward a position above the conveyance surface 102. In various embodiments, biasing member 160 may comprise a coil, or compression, spring.

In accordance with various embodiments, drive roller 108a is configured to translate toward floor 152, in response to a load L being applied to drive roller that is greater than biasing force F of biasing member 160. In response to load L exceeding biasing force F, drive roller 108a and support structure translate toward floor 152, thereby compressing biasing member 160. In various embodiments, first PDU 110a may include a piston 166. Piston 166 may telescope relative to support structure 164. In this regard, piston 166 may translate into spring cavity 162, in response to translation of support structure 164 toward pad 150 and floor 152, and out spring cavity 162, in response to translation of support structure 164 away from pad 150 and floor 152. Piston 166 may be located on and/or coupled to pad 150. In accordance with various embodiments, pads 150 and load cells 140a may be located directed under piston 166 and biasing member 160 (i.e., between biasing member 160 and floor 152 and/or between piston 166 and floor 152). Piston 166 applies a force to load cell 140a in response to load L being applied to drive roller 108a. Load cell 140a is configured to measure the force (i.e. load) applied by piston 166 and output an electrical signal 156 to brake roller 112a and controller 130. Controller 130 may calculate load L based on the electrical signal 156 received from load cell 140 and brake roller 112a may determine how much braking force to generate and/or may adjust the braking force it applies to loads translating over brake roller 112a based on electrical signal 156.

In accordance with various embodiments, load cell 140a may receive power from power source 134 via busses 136. In various embodiments, load cell may be formed of piezoelectric material and may generate electrical signals 156 in response to deflection of piezoelectric material caused by load L and piston 166. In this regard, forming load cells 140a of piezoelectric material may allow for elimination of the busses 136 connected to load cell 140a.

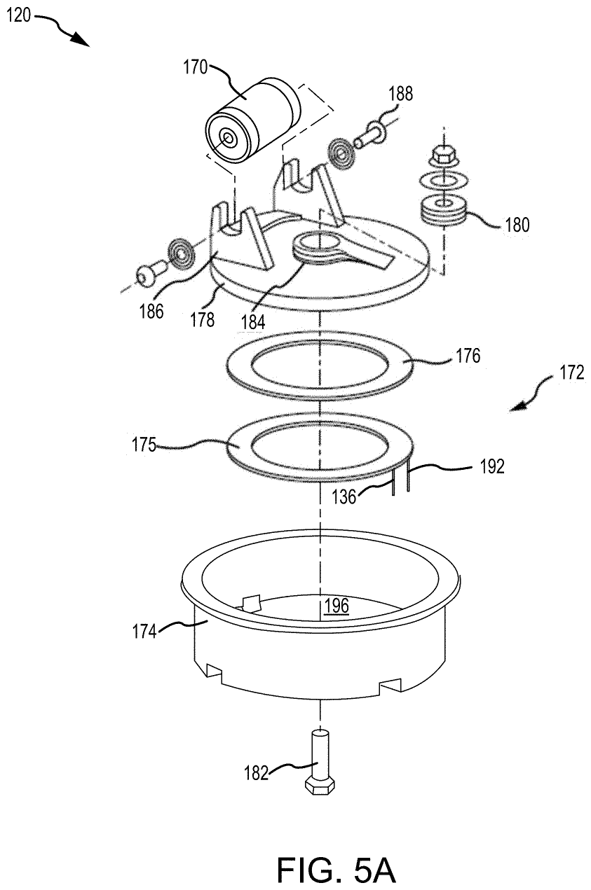

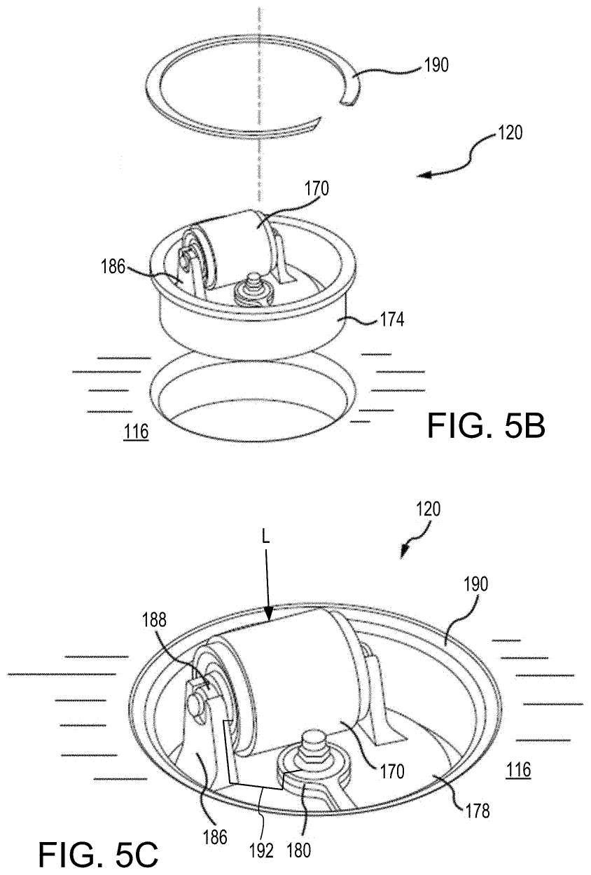

With reference to FIGS. 5A, 5B, and 5C, a brake caster 120 is illustrated in exploded and assembled forms. In accordance with various embodiments, the brake caster 120 includes a brake caster roller 170 and a base assembly 172. The base assembly 172 includes a cup 174 configured for mounting within ball panels 116 described above with reference to FIG. 1B, a load cell 175, a thrust bearing 176, a roller base 178, and a spherical bearing 180. A bolt, or other fastener, 182 is configured to extend through the base assembly 172 and secures the cup 174, the load cell 175, and the thrust bearing 176 to the roller base 178. The bolt 182 also extends through and secures the spherical bearing 180 to a spherical bearing housing 184 located within a center portion of the roller base 178. The combination of the spherical bearing 180 and the thrust bearing 176 enables the roller base 178 to rotate three-hundred sixty degrees (360°) with respect to the cup 174.

Brake caster roller 170 is configured to provide a frictional surface to engage a bottom surface of a ULD. Brake caster roller is secured to a pair of members 186 that extend substantially vertically from the roller base 178. A threaded pin 188 (or a pair of pins, bolts and nuts, or other securement device) may be used to secure the brake caster roller 170 to the pair of members 186. Once assembled, the brake caster 120 may be lowered into the ball panel 116 and secured thereto with a circlip 190 or similar mechanism.

In various embodiments, brake caster roller 170 may be an electromechanical brake roller. In this regard, brake caster roller 170 may generate braking force in response to receiving an electrical signal. Brake caster roller 170 is electrically coupled to load cell 175 via links 192. In various embodiments, link 192 may be located through central apertures in thrust bearing 176 and spherical bearing 180. Link 192 may also be located between roller base 178 and cup 174, or, in various embodiments, link 192 may extend through floor 196 and between cup 174 and ball panel 116. In various embodiments, load cell 175 may receive power from power source 134, with momentary reference to FIG. 1B, via bus 136.

Load cell 175 is configured to detect a load L applied to brake caster roller 170 and output an electrical signal corresponding to the load L to brake caster roller 170. The electrical signals output by load cell 175 may also be sent to controller 130, with momentary reference to FIG. 1B. Controller 130 may be configured to calculate load L based on the electrical signal from load cell 175.

Load cell 175 may be located between thrust bearing 176 and a floor 196 of cup 174. In various embodiments, load cell 175 may comprise strain gauge. The electrical signals generated by load cell 175 may be output to brake caster roller 170 and to controller 130 via links 192.

In accordance with various embodiments, the magnitude of the braking force generated by brake caster roller 170 may be based on the electrical signal received from load cell 175. For example, brake caster roller 170 may generate a first braking force in response to receiving a first electrical signal from load cell 175 and a second braking force, greater than first braking force, in response to receiving a second electrical signal from load cell 175, wherein the first electrical signal is sent in response to a first ULD being located on brake caster roller 170 and the second electrical signal is sent in response to a second, heavier ULD being located on brake caster roller 170.

In various embodiments, the brake caster roller 170 may be configured such that the electrical signals received from load cell 175 cause thermal expansion of friction disks located within brake caster roller 170. In various embodiments, the electrical signals are configured to produce greater thermal expansion when heavier objects are located on brake caster roller 170. For example, a first electrical signal received from load cell 175 may cause a first thermal expansion of the friction disks of brake caster roller 170, thereby generating a first braking force, and a second electrical signal received from load cell 175 may generate a second, greater thermal expansion of the friction disks, thereby generating a second, greater braking force, wherein the first electrical signal is sent in response to a first ULD being located on brake caster roller 170 and the second electrical signal is sent in response to a second ULD being located on brake caster roller 170, the second ULD being heavier than the first ULD.

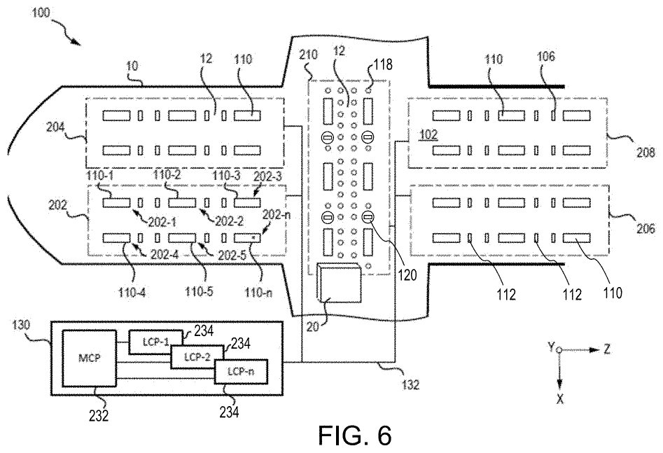

With reference to FIG. 6, a schematic view of a cargo deck 12 of aircraft 10 with cargo handling system 100 is shown in accordance with various embodiments. Cargo handling system 100 may define a plurality of sections of cargo deck 12. In the longitudinal direction, the cargo deck 12 includes a left (or first) lateral track and a right (or second) lateral track along which cargo 20 is to be stowed in parallel columns during flight. In various loading operations, larger cargo 20, which covers both the left and right lateral tracks may be stowed in a single column. In the transverse (i.e., longitudinal) direction, cargo deck 12 may also be separated into an aft section and a forward section. Thus, the left and right lateral tracks are divided into four sections, two forward sections 202 and 204 and two aft sections 206 and 208. Cargo deck 12 may also have a lateral section 210, which may move cargo 20 into and out the aircraft 10 and also transfer cargo 20 between the left and right storage tracks. In accordance with various embodiments, roller trays 104 may be located generally in forward sections 202 and 204 and in aft sections 206 and 208, and ball panel(s) 116 may be located generally in lateral section 210.

Each of the aforementioned sections 202, 204, 206, 208, 210 may include a plurality of PDUs 110. Each PDU 110 has a physical location on conveyance surface 102 which corresponds to a logical address within cargo handling system 100. For purposes of illustration, section 202 is shown having PDUs 110-1, 110-2, 110-3, 110-4, 110-5 and 110-n at respective locations 202-1, 202-2, 202-3, 202-4, 202-5 and 202-n. PDUs 110-1, 110-2, 110-3, 110-4, 110-5 and 110-n may be collectively referred to as the PDUs 110 of section 202. Each physical location for a PDU on conveyance surface 102 may have a unique address identifier.

An operator may control the PDUs 110 using one or more control interfaces of controller 130 configured to permit an operator to selectively control operation of PDUs 110. For example, an operator may selectively control the operation of PDUs 110 through an interface such as a master control panel (MCP) 232. Cargo handling system 100 may also include one or more local control panels (LCP) 234. Master control panel 232 of controller 130 may be in communication with the local control panels 234. Master control panel 232 may be configured to send control signals or command signals to any of PDUs 110, for example, in sections 202, 204, 206, 208, 210. Master control panel 232 may send commands directly to the PDUs 110 and/or to local control panels 234. Local control panels 234 of controller 130 may be configured to send command signals to a subset of PDUs 110, such as the PDUs 110 of one or more of sections 202, 204, 206, 208, 210. For example, a first local control panel LCP-1 may be in communication with the PDUs 110 of forward section 202, a second local control panel LCP-2 may be in communication with the PDUs 110 of forward section 204, and one or more additional local control panels LCP-n may be in communication with the PDUs 110 of one or more of sections 206, 208, 210. Thus, the master control panel 232 and/or local control panels 234 of controller 130 may be configured to allow an operator to selectively engage or activate one or more PDUs 110 to propel cargo 20 along conveyance surface 102.

Each PDU 110 may be configured to receive a command from any of the control panels of controller 130, including master control panel 232 and local control panels 234. Controller 130 may send a command signal through channel 132, which may be in communication with each of the PDUs 110 in a section. For example, a command signal sent to section 202 may be received by each of PDUs 110-1, 110-2, 110-3, 110-4, 110-5 and 110-n.

In accordance with various embodiments, controller 130 is configured to monitor and compare the weight of cargo located in each of sections 202, 204, 206, 208, 210. Controller 130 may determine the weight of the cargo in a particular section based on signals received from the PDU load cells 140 or the brake caster load cells 175 located in the section. Which PDUs 110 and which brake casters 120 include load cells is selected such that each piece of cargo 20 located in cargo deck 12 will be located over and sensed by at least one load cell.

Controller 130 is configured to compare the weight of the cargo in the forward sections 202, 204 to the weight of the cargo in the aft sections 206, 208. Controller 130 may determine a difference between the weight of the cargo in the forward sections 202, 204 and the weight of the cargo in the aft sections 206, 208. Controller 130 may compare the difference between the weight of the cargo in the aft sections 206, 208 and the weight of the cargo in the forward sections 202, 204 and to one or more threshold differences.

Controller 130 may be configured to command master control panel 232 and/or local control panels 234 to display an alert if the weight of the cargo in the aft sections 206, 208 is greater than the weight of the cargo in the forward sections 202, 204 and/or if the difference between the weight of the cargo in the aft sections 206, 208 and the weight of the cargo in the forward sections 202, 204 exceeds a first threshold difference. The alert may be in form of an alarm, a display icon, a flashing light, or any other signal configured to alert an operator to the weight imbalance.

In various embodiments, controller 130 may be configured to command master control panel 232 and/or local control panels 234 to each display the current weight of the cargo in each of sections 202, 204, 206, 208, 210. Displaying the current weight of cargo in each section allows operators to better monitor difference in weight in the aft sections compared to the forwards sections, thereby reducing occurrences of tail tipping.

In various embodiments, controller 130 be configured to command the PDUs 110 in a particular section to deactivate, and thus stop translating cargo 20, in response to the difference between the weight of the cargo in the aft sections 206, 208 and the weight of the cargo in the forward sections 202, 204 exceeding a second threshold difference. For example, if an operator is loading cargo in the aft direction and the difference cargo weight in aft sections 206, 208 as compared to the cargo weight in forward sections 202, 204 exceeds a threshold difference, controller 130 will deactivate the PDUs 110 in aft sections 206, 208 or otherwise stop the PDUs 110 in aft sections 206, 208 from translation cargo in the aft direction. Controller 130 may be configured to reactivate the PDUs 110 in aft sections 206, 208 or otherwise allow the PDUs 110 in aft sections 206, 208 to translate cargo in the aft direction, in response to the weight of the cargo in forward sections 202, 204 increasing, such the difference between the cargo weight in aft sections 206, 208 as compared to the cargo weight in forward sections 202, 204 is less than the second threshold difference. Similarly, if an operator is unloading cargo from the forward sections and the difference in the cargo weight in aft sections 206, 208 becomes too much greater than the cargo weight in forward sections 202, 204 (i.e., exceeds the second threshold), controller 130 will deactivate the PDUs 110 in forward sections 202, 204 or otherwise stop the PDUs 110 in forward sections 202, 204 from translating cargo in the aft direction. The second threshold difference is selected to be less than a weight difference associated with a tail tip. In this regard, controller 130 deactivating the PDUs 110 in the forward or aft sections is likely to prevent or substantially reduce the chances of a tail tip.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A power drive unit for a cargo handling system, comprising:
a drive roller;
a motor configured to drive a rotation the drive roller;
a biasing member configured to bias the drive roller in a first direction; and
a load cell configured to detect a load applied to the drive roller and output an electrical signal.

2. The power drive unit of claim 1, further comprising a pad coupled to a bottom surface of the power drive unit, wherein the drive roller extends past an upper surface of the power drive unit, the upper surface being opposite the bottom surface, and wherein the pad comprises the load cell.

3. The power drive unit of claim 2, wherein further comprising:
a support structure coupled to the drive roller; and
a piston configured to telescope relative to the support structure, wherein the piston is configured to apply force to the load cell.

4. The power drive unit of claim 1, wherein the load cell is configured to output the electrical signal to a controller.

5. The power drive unit of claim 1, wherein the load cell is configured to output the electrical signal to a brake roller.

6. The power drive unit of claim 1, wherein the load cell comprises a strain gauge.

7. The power drive unit of claim 1, wherein the load cell comprises a piezoelectric material.

8. A cargo handling system, comprising:
a roller tray; and
a first power drive unit located in the roller tray, the first power drive unit comprising:
a first drive roller;
a motor configured to drive a rotation the first drive roller; and
a first load cell configured to detect a first load applied to the first drive roller.

9. The cargo handling system of claim 8, further comprising a brake roller electrically coupled to the first load cell.

10. The cargo handling system of claim 9, wherein the brake roller is configured to adjust a braking force based on an electrical signal output by the first load cell.

11. The cargo handling system of claim 10, wherein a first electrical signal output by the first load cell is configured to generate a first braking force, and wherein a second electrical signal output by the first load cell is configured to generate a second braking force, the second braking force being greater than the first braking force.

12. The cargo handling system of claim 11, wherein the first electrical signal output is configured to generate a first amount of thermal expansion in one more friction disks of the brake roller, and wherein the second electrical signal output is configured to generate a second amount of thermal expansion in the one more friction disks of the brake roller.

13. The cargo handling system of claim 8, further comprising a brake caster, the brake caster including:
a cup;
a brake caster roller configured to swivel relative to the cup;
a thrust bearing located between the brake caster roller and a floor of the cup; and
a second load cell located between the thrust bearing and the floor of the cup.

14. The cargo handling system of claim 8, further comprising a second power drive unit, the second power drive unit including:
a second drive roller; and
a second load cell configured to detect a second load applied to the second drive roller.

15. The cargo handling system of claim 14, further comprising a controller electrically coupled to the first load cell and the second load cell, wherein the controller is configured to determine a difference between a weight of an aft section of the cargo handling system and a weight of a forward section of the cargo handling system, the controller may determine the difference using a first electrical signal received from the first load cell and a second electrical signal received from the second load cell.

16. An article of manufacture including a tangible, non-transitory computer-readable storage medium having instructions stored thereon for controlling a cargo handling system, wherein the instructions, in response to execution by a controller, cause the controller to perform operations comprising:
receiving, by the controller, a first electrical signal from a first load cell, wherein the first load cell is operably coupled to a first power drive unit;
receiving, by the controller, a second electrical signal from a second load cell, wherein the second load cell is operably coupled to a second power drive unit;
determining, by the controller, an aft cargo weight in an aft section of the cargo handling system using on the first electrical signal; and
determining, by the controller, a forward cargo weight in a forward section of the cargo handling system using on the second electrical signal.

17. The article of claim 16, wherein the operations further comprise:
calculating, by the controller, a difference between the aft cargo weight and the forward cargo weight; and
comparing, by the controller, the difference between the aft cargo weight and the forward cargo weight to a difference threshold.

18. The article of claim 17, wherein the operations further comprise commanding, by the controller, at least one of a master control panel of the cargo handling system or a local control panel of the cargo handling system to display an alert if the difference between the aft cargo weight and the forward cargo weight is greater than the difference threshold.

19. The article of claim 17, wherein the operations further comprise deactivating, by the controller, at least one of the first power drive unit or the second power drive unit if the difference between the aft cargo weight and the forward cargo weight is greater than the difference threshold.

20. The article of claim 19, wherein the operations further comprise reactivating, by the controller, the at least one of the first power drive unit or the second power drive unit in response to the difference between the aft cargo weight and the forward cargo weight decreasing to less than the difference threshold.
